(19) United States
(12) Patent Application Publication
(10) Pub. No.: US 2019/0184630 A1
(43) Pub. Date: Jun. 20, 2019

(54) THREE DIMENSIONAL PRINTER RESIN REPLENISHMENT METHOD

(71) Applicant: 3D Systems, Inc., Rock Hill, SC (US)

(72) Inventors: Peter Scott Turner, Venice, CA (US); Kirt Winter, San Diego, CA (US); Winthrop Childers, San Diego, CA (US)

(21) Appl. No.: 16/278,454

(22) Filed: Feb. 18, 2019

Related U.S. Application Data
(63) Continuation-in-part of application No. 15/899,452, filed on Feb. 20, 2018.
(60) Provisional application No. 62/460,947, filed on Feb. 20, 2017.

(51) Int. Cl. B29C 64/124; B33Y 10/00; B33Y 30/00; B33Y 50/02; B29C 64/20; B29C 64/393

(52) U.S. Cl. CPC B29C 64/124; B33Y 10/00; B29C 64/393; B33Y 50/02; B29C 64/20; B33Y 30/00

(57) ABSTRACT

A three dimensional printer includes a vessel, a light engine, a fixture, a movement mechanism, a sensor, and a controller. The vessel is for containing a liquid photocurable resin and includes a transparent sheet defining a lower surface through which the resin can be illuminated. The light engine is disposed and configured to selectively illuminate the resin through the transparent sheet. The fixture is for supporting a three dimensional article of manufacture having a lower face immersed in the resin in facing relation with the transparent sheet. The movement mechanism is configured for controllably translating the fixture to adjust a vertical height of the lower face above the transparent sheet. The sensor is configured to monitor a transient displacement of the transparent sheet during the translation.

### CROSS REFERENCE TO RELATED APPLICATIONS

This non-provisional patent application is a continuation-in-part of U.S. Ser. No. 15/899,452, entitled “THREE DIMENSIONAL PRINTER RESIN REPLENISHMENT METHOD,” filed on Feb. 20, 2018 which claims priority to U.S. Provisional Application Ser. No. 62/460,947, filed on Feb. 20, 2017, incorporated herein by reference.

### FIELD OF THE INVENTION

The present disclosure concerns an apparatus and method for fabrication of solid three dimensional (3D) articles of manufacture from energy curable materials. More particularly, the present disclosure concerns a way of optimizing the speed and output quality of a three dimensional (3D) printer that utilizes photocurable resins.

### BACKGROUND

Three dimensional (3D) printers are in rapidly increasing use. One class of 3D printers includes stereolithography printers having a general principle of operation including the selective curing and hardening of radiation curable (photocurable) liquid resins. A typical stereolithography system includes a containment vessel holding the curable resin, a movement mechanism coupled to a support surface, and a controllable light engine. The stereolithography system forms a three dimensional (3D) article of manufacture by selectively curing layers of the photocurable resin.

In one system embodiment the vessel includes a transparent sheet that forms part of a lower surface of the vessel. The support surface is positioned above and in facing relation with the transparent sheet. The following steps take place: (1) The movement mechanism positions the support surface whereby a thin layer of the photocurable resin resides between the support surface and the transparent sheet. (2) The light engine transmits pixelated light up through the transparent sheet to selectively cure a layer of the photocurable resin onto the support surface. (3) The movement mechanism then incrementally raises the support surface. Steps (2) and (3) are repeated to form a three dimensional (3D) article of manufacture having a lower face in facing relation with the transparent sheet.

One challenge is the “fouling” of the transparent sheet with cured polymer. Ideally the polymer would only cure on the support surface and the lower face of the 3D article of manufacture. However, some polymer may cure upon the lower window. Over time, the cured polymer on the window will interfere with proper operation of the 3D printer. Also, the lower face may stick to the lower window. To overcome this problem, various solutions have been deployed including providing a release coating on the lower window and/or using chemical inhibitors to prevent the resin from curing on or near the lower window.

Another challenge with such a system is how to maintain a supply of fresh resin at a build plane proximate to the lower face. When the lower face of the 3D article of manufacture has a solid and large cross sectional area, the resin can become depleted at the build plane. Up and down motion of the lower face of the 3D article of manufacture might be used to replenish the thin layer of resin. This up and down motion can impart stresses upon the lower face of the 3D article of manufacture, resulting in a decrease in quality. Slowing down the up and down motion can reduce these stresses but will result in longer processing times. What is needed is a system that provides high speed operation without a reduction in quality of the 3D article of manufacture.

### BRIEF DESCRIPTION OF THE FIGURES

FIG. 1A is a schematic diagram depicting a first embodiment of a three dimensional (3D) printing system using a non-contact sensor having an emitter and detector.

FIG. 1B is a schematic diagram depicting a second embodiment of a three dimensional (3D) printing system using “contact” sensor that is in physical contact with or mounted to a transparent membrane.

FIG. 2 is a flowchart depicting an embodiment of a method for operating a three dimensional (3D) printing system to manufacture a three dimensional article.

FIG. 3 is an exemplary schematic timing diagram depicting a height H(t) versus time t of a lower face of a three dimensional (3D) object of manufacture above a transparent sheet.

FIG. 4 is an exemplary schematic timing diagram depicting a height H(t) and a transient displacement s(t) versus time t. H(t) is a height of a lower face of a three dimensional (3D) object of manufacture above a reference plane which may correspond to an equilibrium position of a transparent sheet. The transient displacement s(t) is a dynamically varying displacement or vertical position of a portion of the transparent sheet from an equilibrium position.

FIG. 5 is a top view of an exemplary vessel containing resin and a three dimensional (3D) object of manufacture having a solid circular cross section.

FIG. 6 is a side cross sectional view of an exemplary vessel containing resin and a three dimensional (3D) object of manufacture.

### SUMMARY

In a first aspect of the disclosure a three dimensional (3D) printer includes a vessel, a light engine, a fixture, a movement mechanism, a sensor, and a controller. The vessel is for containing a liquid photocurable resin and includes a tensioned transparent sheet defining at least part of a lower surface through which the resin can be illuminated. The light engine is disposed and configured to selectively harden the resin at a build plane above the transparent sheet. The fixture is for supporting a three dimensional (3D) article of manufacture whereby a lower face of the 3D article of manufacture is immersed in the resin in facing relation with the transparent sheet. The movement mechanism is configured for controllably translating the fixture whereby a vertical height H(t) of the lower face of the 3D article of manufacture can be controlled. The sensor is configured to sense a transient displacement of the transparent sheet from an unperturbed position. The controller is configured to: (a) activate the movement mechanism to position the lower face of the 3D article of manufacture at the build plane; (b) activate the light engine to selectively harden a layer of resin onto the lower face; (c) repeat (a) and (b) N−1 times, N is two or more, during repeating includes an incremental vertical motion of a distance d (described below); (d) activate the movement mechanism to translate the lower face upwardly by a distance of D and then downwardly to the build plane pursuant to a pump cycle, D is at least two times d; (e) concurrent with the motion in (a) and (d), monitor a signal from the sensor that is indicative of the vertical displacement; (f) update a motion parameter based at least partly upon the signal from the sensor, the motion parameter defines motion in one or more of steps (a) and (d); and (g) repeat steps (a) to (f) until the 3D article of manufacture is completed.

Step (a) includes incrementally raising the lower face by a distance d to offset a thickness of material solidified onto the lower face of the three dimensional article. D can be equal to at least four times d, at least 10 times d, at least 50 times d, or at least 100 times d. The distance d can be in range of 10 to 100 microns or about 30 microns in particular embodiments.

In one implementation the sensor is a non-contact sensor that does not directly physically contact the transparent sheet. The sensor can include a proximity sensor having an emitter and detector. The sensor can include an interferometer. The sensor can be an individual sensor or a plurality or array of sensors.

In another implementation the sensor contacts or is mounted upon the transparent sheet. The sensor can be an accelerometer. The sensor can be an LVDT (linear variable differential transformer) sensor. The sensor can be an individual sensor or a plurality or array of sensors.

In yet another implementation the light engine includes a light source and a spatial light modulator. The spatial light modulator operates to selectively control pixel elements across a build plane over which the resin is selectively cured. In one embodiment the spatial light modulator is a digital mirror device. The spatial light modulator receives unprocessed light from the light source and reflects or transmits pixelated and processed light. The light engine includes optics that deliver the processed light to the build plane within the resin and proximate to the lower face of the 3D article of manufacture.

In a further implementation the controller is electrically and/or wirelessly coupled to the light engine, the movement mechanism, and to the sensor. The controller includes a processor coupled to an information storage device. The information storage device includes a non-transient or non-volatile storage device that stores instructions that, when executed by the processor, process signals from the sensor and control the light engine and the movement mechanism. The controller can be contained in a single IC (integrated circuit) or multiple ICs. The controller can be disposed at one location or distributed in multiple locations within the three dimensional printing system.

In a yet further implementation updating the motion parameter includes updating motion when step (a) is repeated. Updating the motion parameter can include updating the number N (total number of times (a) and (b) are executed before a pump cycle).

In another implementation updating the motion parameter includes updating motion when step (d) is executed. This can include updating the pump distance D. This can include updating a peak vertical velocity during pumping.

In yet another implementation a translation velocity of the lower face of the 3D article of manufacture is adjusted in real time based upon a signal from the sensor. The translation velocity can be decreased if the signal from the sensor indicates that the transient displacement has a magnitude that exceeds a designated upper control limit. The translation velocity can be decreased if the signal from the sensor indicates that the transient displacement versus time has a magnitude that exceeds a designated upper control limit. The translation velocity can be increased if the signal from the sensor indicates that the transient displacement has a magnitude that is less than a designated lower control limit. The translation velocity can be increased if the signal from the sensor indicates that a slope of the transient displacement versus time is less than a lower control limit.

In a further implementation the transient displacement versus time rises and then falls while the lower face of the 3D article of manufacture is being translated upwardly away from the transparent sheet. The upward translation can be halted in real time in response to a real time analysis of the transient displacement versus time. When the magnitude of the transient displacement begins to rapidly fall the upward translation can be halted.

In a yet further implementation the controller is configured to define the pump cycle based upon a parametric correlation that correlates pump cycle parameters with at least a geometry of the lower face of the 3D article of manufacture. The pump cycle parameters include a pump distance D and a translation velocity of the lower face of the 3D article of manufacture. In a first embodiment a lookup table correlates a pump cycle parameter with a lower face geometric parameter. In the first embodiment the lookup table is updated based upon an analysis of the signal from the sensor. In a second embodiment a functional relationship relates a pump cycle parameter to a lower face geometric parameter. In the second embodiment the functional relationship is updated based upon an analysis of the signal from the sensor.

In another implementation a resin flow regime can be defined between the lower face of the 3D article of manufacture and the transparent sheet. The resin flow regime can be laminar or turbulent based upon a Reynolds number. The pump cycle is updated to maximize the Reynolds number while maintaining laminar flow and avoid turbulent flow. The pump cycle can also have an upper limit on the dynamic force for a very viscous resin.

### DETAILED DESCRIPTION OF THE PREFERRED EMBODIMENTS

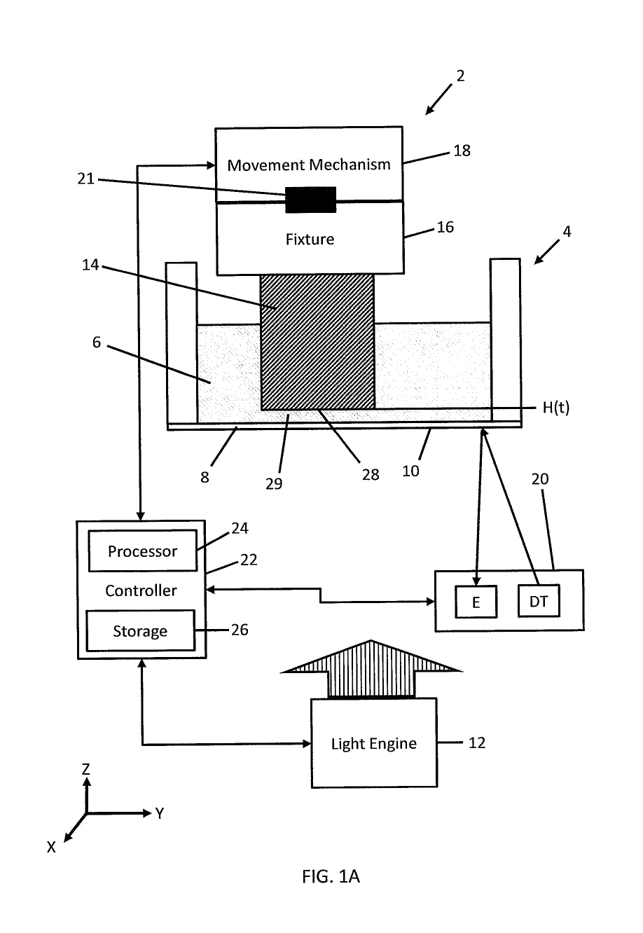

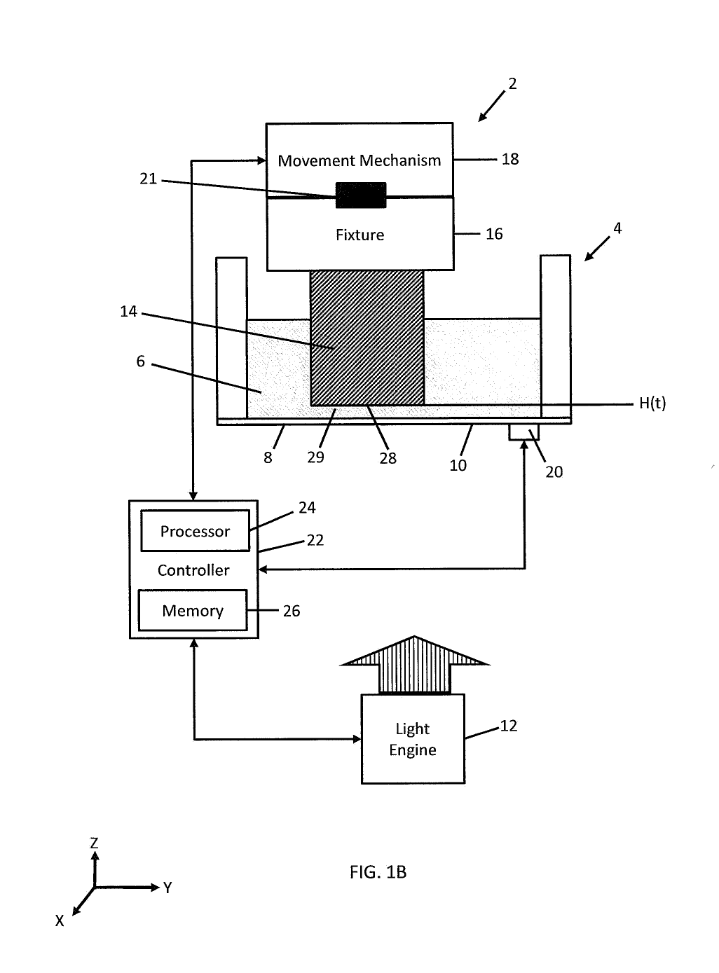

FIG. 1A is a schematic diagram representation of a first embodiment of a three dimensional (3D) printing system 2. Indicated in FIGS. 1A and 1B are mutually perpendicular axes X, Y, and Z. Axes X and Y are lateral axes. In some embodiments X and Y are also horizontal axes. Axis Z is a central axis. In some embodiments Z is a vertical axis. In some embodiments the direction +Z is generally upward and the direction −Z is generally downward.

Three dimensional printing system 2 includes a vessel 4 containing a photocurable resin 6. Vessel 4 includes a transparent sheet 8 that defines at least a portion of a lower surface 10 of vessel 4. A light engine 12 is disposed to project light up through the transparent sheet 8 to solidify layers of photocurable resin 6 to progressively form a three dimensional article of manufacture 14. The three dimensional article of manufacture 14 is attached to and thereby supported by a fixture 16. A movement mechanism 18 is coupled to fixture 14 for translating the fixture 16 along the vertical axis Z.

The three dimensional printing system 2 includes a sensor 20 that is configured to output a signal indicative of a transient vertical displacement or position s(t) of a portion of the transparent sheet 8 from an equilibrium position. When the three dimensional article 14 is moved up and down in resin 6, a transient force is generated upon the transparent sheet 8 which causes the transient displacement s(t). The signal outputted by sensor 20 can be indicative of a position, a velocity, and/or an acceleration. Alternatively, the signal outputted by sensor 20 can be a processed signal that characterizes or quantifies the transient displacement s(t) in some way.

In the illustrated embodiments of FIGS. 1A and 1B, the sensor 20 can be a single sensor 20. Alternatively, the sensor 20 can include a plurality or array of sensors 20 which can sense s(t) for a plurality or array of locations upon the transparent sheet 8.

In the illustrated embodiment, the sensor 20 includes an emitter E and detector DT. The emitter E emits radiation that partially reflects from the transparent sheet 8 and is then received by the detector DT. In one particular embodiment, the sensor 20 includes components of a proximity sensor. In another particular embodiment, the sensor 20 includes components of an interferometer.

A controller is 22 is electrically or wirelessly coupled to the light engine 12, the movement mechanism 18, and the sensor 20. Controller 22 includes a processor 24 coupled to an information storage device 26. The information storage device 26 includes a non-transient or non-volatile storage device that stores instructions that, when executed by the processor 24, analyze and process signals from the sensor 20 and control the light engine 12 and the movement mechanism 18. Controller 22 is contained in a single IC (integrated circuit) or multiple ICs. Controller 22 can be disposed at one location or distributed among multiple locations in three dimensional printing system 2.

The three dimensional article of manufacture 14 has a lower face 28 that faces the transparent sheet 8. As light engine 12 selectively applies light energy through the transparent sheet 8 it selectively polymerizes resin proximate to a “build plane” 29 which can be coincident or proximate to the lower face 28. This has the effect of selectively building or forming a layer of resin onto lower face 28. The movement mechanism, under control of controller 22, controls a height H(t) of the lower face 28. In the illustrated embodiment, H(t) is approximately a distance between the lower face 28 and the transparent sheet 8 in an equilibrium position when it is nearly flat or planar.

The transparent sheet 8 is under tension to maintain planarity of the build plane 29. As the lower face 28 is translated vertically, the pressure of the resin 6 will tend to deflect the transparent sheet 8. This deflection is transient and the transparent sheet 8 will tend to move back to the equilibrium position when there is no motion of the lower face 28. The distance s(t) is the transient vertical displacement of the transparent sheet 8 from an equilibrium position. The displacement s(t) is transient because the tension in the transparent sheet 8 returns the transparent sheet to its equilibrium position.

In an alternative embodiment, a second sensor 21 is also coupled to the controller 22. The second sensor 21 emits a second signal received by controller 22 that is indicative of a dynamic force F(t) experienced by the fixture 16 during vertical motion of the lower face 28 in the resin 6.

FIG. 1B is a schematic diagram representation of a second embodiment of a three dimensional (3D) printing system 2 which is similar to the first embodiment of FIG. 1A except for the illustrated sensor 20. In the illustrated embodiment, sensor 20 is attached or mounted to the transparent sheet. The illustrated sensor 20 can be referred to as a “contact sensor” because it physically contacts the transparent sheet 8. Sensor 20 can include an accelerometer. In another embodiment, sensor 20 is an LVDT (linear variable differential transformer) having a movable portion that is urged against the transparent sheet 8. In some embodiments, sensor 20 can include a plurality or array of sensors 20 attached to or contacting the transparent sheet 8. In yet other embodiments, sensor can includes a combination of a non-contact sensor 20 (as illustrated in FIG. 1A) and a contact sensor 20 (as illustrated in FIG. 1B).

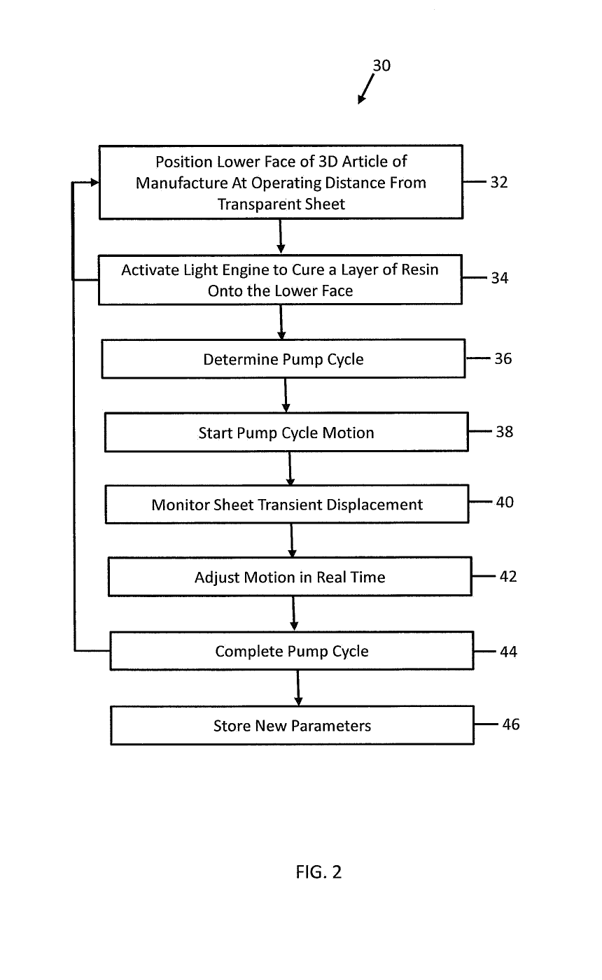

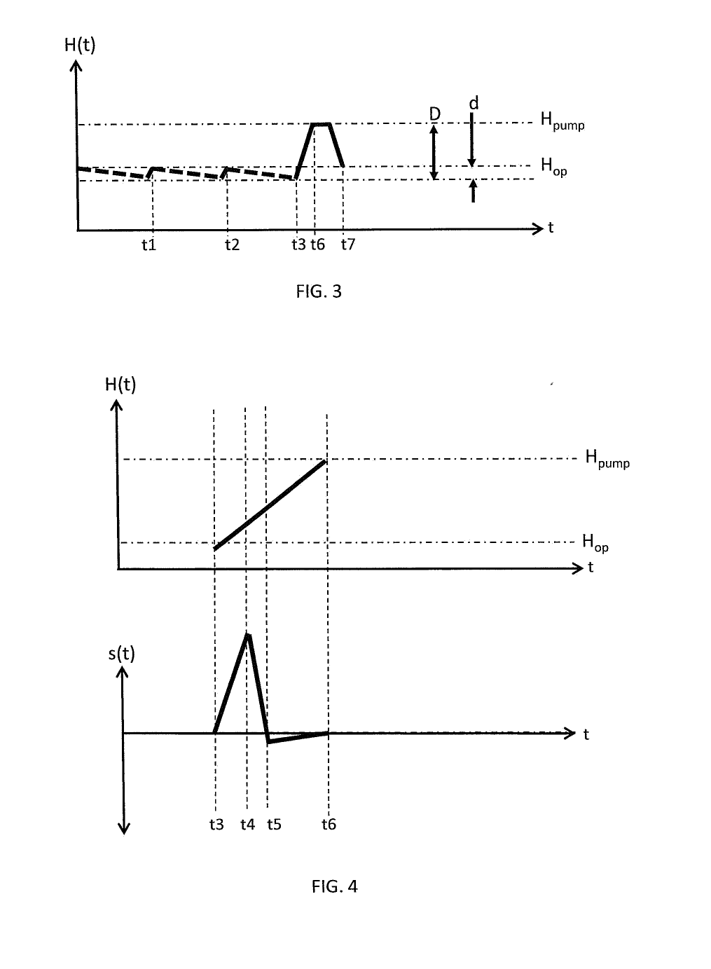

FIG. 2 is a flowchart depicting an exemplary method 30 of forming a three dimensional article of manufacture 14 with a three dimensional (3D) printing system 2. FIG. 3 is an exemplary graph of H(t) versus time t that can correspond to a part of method 30. The two will be discussed at the same time.

According to step 32 the lower face 28 of the three dimensional article of manufacture 14 is positioned at an operating height Hₒₚ above the transparent sheet 8. Step 32 is initially depicted by the left side of the FIG. 3 graph at t=0.

According to step 34, the light engine 12 is activated to photo polymerize a layer of resin at the build plane 29 and onto the lower face 28. Step 34 corresponds to the dashed line between t=0 and t=t1 in FIG. 3. After the polymerization of step 34, the distance H(t) is reduced by a thickness of photocure resin that has been added onto lower face 28. The method then proceeds back to step 32 in which the lower face is raised back to an operating height Hₒₚ.

Steps 32 and 34 are repeated one or more (N−1 in which N is at least equal to two) times before proceeding to step 36. FIG. 3 depicts these as being repeated twice but the number of times steps 32 and 34 are repeated can vary. They may be not be repeated at all or can be repeated 1, 2, 3, 4, 5, 6, 7, or more times before proceeding to step 36. The number of repeats can be a function of various factors such as the geometry of the lower face 28, resin 6 rheology, and cure depth into the resin. At or around time t1 and time t2 the lower face 28 is incrementally raised by a distance d to provide the proper operating height Hₒₚ before operating the light engine.

When the lower face 28 has a relatively large geometry the resin 6 may not completely refill between the lower face 28 and the transparent sheet 8 between t=0 and t=t3. At some point the quality of added layers of resin is impaired. Then a “pump cycle” can be performed. An exemplary pump cycle is illustrated according to FIG. 3 between time t=t3 and t=t7. The lower face 28 is raised to H(t)=Hₚᵤₘₚ above the transparent film 8. The distance that lower face 28 is vertically raised between t=t3 and t=t6 will be referred to as pump distance D.

According to step 36 a pump cycle is determined or defined. This can be based upon factors such as a geometry of the lower face 28, a geometry of the three dimensional article 14 proximate to or near the lower face 28, and rheological properties of the resin 6. The pump cycle defines D, a velocity profile or curve including H(t) versus t between t=t3 and t=t7. In another embodiment of step 36, the pump cycle is determined based upon a conservative “nominal” curve of H(t) versus t or a prior stored profile.

According to step 38 the movement mechanism 18 begins the pump cycle. According to 40 a signal from sensor 20 is monitored during all motion of the lower face 28 during steps 32, 38, and 44 (40 can occur either continuously or multiple times during the process 30). The signal is indicative of the transient displacement s(t) of the transparent sheet along axis Z. An “idealized” transient displacement s(t) versus time is illustrated as s(t) versus time t in FIG. 4. This is idealized because an actual graph may have non-linear segments and added reverberations.

The top graph of FIG. 4 depicts H(t) versus time t between t=t3 and t=t6. While FIGS. 3 and 4 depict motions as linear (constant slope) between various times, this is for illustrative purposes. The actual motion may be non-linear in order to optimize a resin flow regime between the lower face 28 and the transparent sheet 8.

The bottom graph of FIG. 4 depicts the transient displacement s(t) versus time inferred from sensor 20 between times t=t3 and t=t6. Between t=t3 and t=t4 a viscous drag of the resin causes the transparent sheet to be rapidly flexed upwardly as the lower face 28 is raised. Then, at t=t4, the transparent sheet 8 “breaks free” as resin rushes in between the lower face 28 and the transparent sheet 8. The sheet 8 may overshoot as at t=t5 before returning to an equilibrium position at t=t6.

According to step 42, motion for steps 32-44 can be adjusted in real time in response to and concurrently with analyzing the step 40 signal. Step 42 does not necessarily occur unless the analysis determines that transient displacement curve s(t) is not optimal. There are a number of embodiments for which step 42 is invoked and what follows are some exemplary embodiments.

In some embodiments, there is an upper control limit for the transient displacement s(t) versus time t between t3 and t4. Too high of a displacement can result in damage to the three dimensional article of manufacture 14 and possibly even to the transparent sheet 8. If the analysis shows that a magnitude of s(t) has exceeded the upper control limit then the slope of H(t) versus t (which equals the upward translation velocity of the fixture 16 is reduced in order to reduce a peak displacement s(t) for the motion (shown as a peak of the curve in FIG. 4).

In some embodiments, there is a lower control limit for the transient displacement s(t) at a particular time t. Too low of a transient displacement s(t) indicates an opportunity to increase a build rate for the three dimensional article of manufacture 14 without adverse effects. If the analysis of step 40 indicates that a magnitude of the transient displacement s(t) is below the lower control limit, then the rate of upward translation of the lower face 28 (which equals the slope of height H(t) versus time t) is increased.

In some embodiments, the pump cycle being executed is based upon an expected graph of transient displacement s(t) versus time t. Based on the analysis it may be determined that the time t4 occurs earlier than expected—in other words, the transient displacement s(t) begins to decline rapidly earlier than expected. Then the pump cycle can be temporally shortened by reducing times t=t6 and t=t7. Doing so increases the build rate for the three dimensional article of manufacture 14 while still assuring a complete reflow of resin between the lower face 28 and the transparent sheet 8.

In some embodiments, the number N (number of positioning and light engine activation) can be adjusted based upon the transient displacement s(t) during the incremental motion of repeating step 32. If s(t) is above a control limit, the number N can be decreased. If s(t) is below a control limit, the number N can be increased.

According to step 44, the pump cycle from t=t3 to t=t7 is completed. Step 44 actually coincides with step 32 at which the lower face is again positioned at the operating distance Hₒₚ. The cycle of steps 32 to 44 can be repeated until the three dimensional article of manufacture 14 is completed.

According to step 46 a new parametric correlation is stored that correlates the pump cycle with at least the geometry of the lower face 28 and possibly other parameters. This new parametric correlation can be used for subsequent repeats of the steps 32 to 44. This parametric correlation can take on various embodiments.

In a first embodiment, the parametric correlation is defined by a lookup table. Step 46 can include modifying the lookup table correlating the pump cycle to various input variables such as the geometry of lower face 28. Alternatively, step 46 can include pointing to a new lookup table.

In a second embodiment the parametric correlation is defined by one or more functional relationships correlating the pump cycle to the geometry of lower face 28. The functional relationship includes function parameters such a multiplicative constants. According to the second embodiment, step 46 includes modifying one or more of the function parameters and thereby modifying the functional relationship. The functional relationship can be a multiplicative factor, and updating the parameter can be updating the multiplicative factor.

In a third embodiment, the parametric correlation is defined by a combination of one or more lookup tables and one or more functional relationships. Step 46 can include modifications to a lookup table and/or a functional relationship.

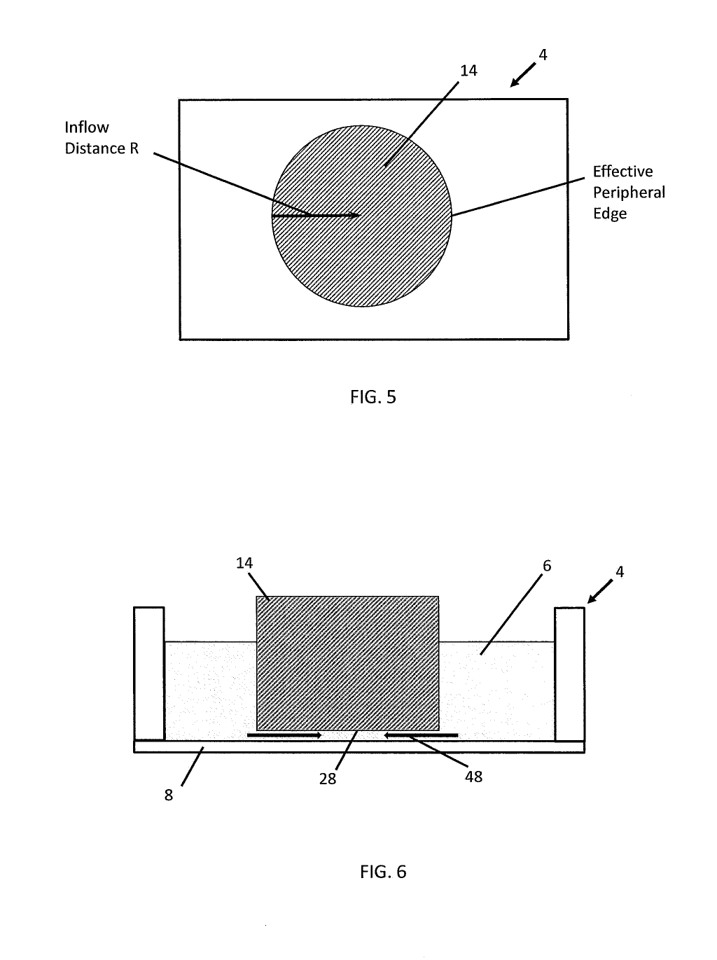

FIGS. 5 and 6 are simplified diagrams for illustrating a simple geometry of a cylindrical three dimensional article of manufacture 14 for the purpose of discussing the geometry of lower face 28. FIG. 5 is a top view and FIG. 6 is a side view of the vessel 4 containing resin 6 and three dimensional article of manufacture 14. The required pump distance D correlates increasingly with an inflow radius R which is a lateral radius of the circular three dimensional article of manufacture 14. Thus for such a simple geometry a lookup table can correlate the pump distance D and/or N with R. More complicated geometries won't have such a simple correlation, but for such geometries an equivalent inflow radius R can be estimated. By utilizing the method 30, the correlation (D and/or N versus R) can be automatically improved over time for a given resin 6.

Generally speaking, as R increases, N decreases and D increases. As the resin viscosity increases, N decreases and D increases. As R increases, pump velocities are decreased. As resin viscosity increases, pump velocities are decreased.

As the lower face 28 of the three dimensional article of manufacture 14 is raised above the transparent sheet 8, resin inflows as indicated by arrows 48. If the translation velocity H(t) versus t is of a low enough magnitude, the resin flow 48 regime will be laminar and flow vectors will tend to be uniformly radially inward. But as H(t) versus t is increased above a certain threshold, the resin flow 48 regime becomes turbulent and irregular. Such a flow regime is not optimal. The optimal resin flow 48 rate is an upper limit for laminar flow before the flow becomes turbulent. The method 30 including steps 42 and 46 can be performed to provide the highest magnitude of translation velocity (height H(t) versus time t) for which the resin flow 48 is laminar and an upper limit on the transient displacement s(t) is not exceeded.

Variables that define the pump cycle can vary dramatically. Operating with optimal laminar flow requires the correlation of a number of variables. The effective radius (inflow distance) R of a given layer of material can vary dramatically. A smaller effective radius can be in the range of 1 to 5 millimeters. A larger effective radius range can be in a range of 5 to 500 millimeters or more.

Rheological properties of the resin 6 combine with the geometry to determine an optimal pump cycle. The pump cycle may include a pump distance D as small as 100 to 300 microns or as large a 500 to 5000 microns depending on lower face 28 geometry, resin 6 rheology, and possibly other factors. The translation velocity (slope of height H(t) versus time t) can also vary widely. The acceptable maximum transient displacement s(t) is a function of factors including the resin 6 rheology and the lower face 28 geometry. For a given resin rheology this can be determined by finding the boundaries of the transient displacement s(t) for a given geometry.

For geometries other than a circle, the inflow distance R can be computed by analyzing how far resin must flow from various boundaries before covering a particular two dimensional shape of a cross-section. For a rectangle, 2R is generally equal to the width along the minor axis. This would also be true for a simple oval. For more complex shapes, an “erosional” method can be used to compute R. The distance of erosion at which the simple shape is gone equals the inflow distance. Yet other shapes like a comb-shape or shapes that have multiple portions can be estimated with algorithms. In one embodiment, step 36 is initially based upon a correlation of the pump cycle (D and vertical speed of pumping) with the computed inflow distance R and rheological properties of the resin being used. Then, step 42 is a correction based upon the transient displacement.

The specific embodiments and applications thereof described above are for illustrative purposes only and do not preclude modifications and variations encompassed by the scope of the following claims.

What we claim is:

1. A three dimensional (3D) printer comprising:
a vessel for containing a liquid resin, the vessel having a tensioned transparent sheet through which the resin can be illuminated;
a light engine disposed to selectively harden the resin at a build plane above the transparent sheet;
a fixture for supporting a 3D article of manufacture whereby a lower face of the 3D article of manufacture is immersed in the resin in facing relation with the transparent sheet;
a movement mechanism for controllably translating the fixture whereby a vertical height of the lower face can be controlled;
a sensor configured to sense a transient displacement of the transparent sheet from an unperturbed position;
a controller configured to:
(a) activate the movement mechanism to position the lower face of the 3D article of manufacture at the build plane;
(b) activate the light engine to selectively harden a layer of resin onto the lower face;
(c) repeat (a) and (b) N−1 times, N is two or more, repeating (a) includes an incremental upward vertical motion of a distance d;
(d) activate the movement mechanism to translate the lower face upwardly by a distance of D and then downwardly to the build plane pursuant to a pump cycle, D is at least two times d;
(e) concurrent with the motion in (a) and (d), monitor a signal from the sensor that is indicative of the vertical displacement;
(f) update a motion parameter based at least partly upon the signal from the sensor, the motion parameter defines motion in one or more of steps (a) and (d); and
(g) repeat steps (a) to (f) to build the 3D article of manufacture.

2. The three dimensional (3D) printer of claim 1 wherein the sensor includes a proximity sensor having an emitter and detector.

3. The three dimensional (3D) printer of claim 1 wherein the sensor includes an interferometer.

4. The three dimensional (3D) printer of claim 1 wherein the sensor includes an accelerometer.

5. The three dimensional (3D) printer of claim 1 wherein updating the motion parameter includes updating motion in step (a).

6. The three dimensional (3D) printer of claim 5 wherein the updated motion parameter includes the number N.

7. The three dimensional (3D) printer of claim 1 wherein the updated motion parameter includes updating motion in step (d).

8. The three dimensional (3D) printer of claim 1 wherein the updated motion parameter updates the motion in real time.

9. The three dimensional (3D) printer of claim 1 wherein a translation velocity of the lower face is adjusted in real time based upon the signal from the sensor.

10. The three dimensional (3D) printer of claim 9 wherein the translation velocity is decreased if the signal from the sensor indicates that the transient displacement has a magnitude that exceeds a designated upper control limit.

11. The three dimensional (3D) printer of claim 9 wherein the translation velocity is increased if the signal from the sensor indicates that the transient displacement has a magnitude that is less than a designated lower control limit.

12. The three dimensional (3D) printer of claim 1 wherein the transient displacement rises and then falls while the lower face is being translated upwardly from the transparent sheet, the upward translation is halted in real time in response to a real time analysis of the transient displacement versus time.

13. The three dimensional (3D) printer of claim 1 wherein the controller is configured to define the pump cycle in part based upon a parametric correlation that correlates the pump cycle with at least a geometry of the 3D article.

14. The three dimensional (3D) printer of claim 13 wherein the signal from the sensor is analyzed and the parametric correlation is updated in response.

15. The three dimensional (3D) printer of claim 1 wherein D is at least equal to four times d.

16. The three dimensional (3D) printer of claim 1 wherein D is at least equal to ten times d.

17. A method of manufacturing a 3D article using a 3D printer having including a vessel containing resin and having a transparent sheet at a lower portion of the resin comprising:
(a) positioning a lower face of the 3D article proximate to a build plane above the transparent sheet;
(b) projecting pixelated light up through the transparent sheet to selectively cure resin onto the lower face;
(c) repeating (a) and (b) N−1 times, N is at least equal to 2, motion during repeating (a) includes a vertical displacement equal to d;
(d) executing a pump cycle which includes raising the lower face above the build plane and then lowering the lower face to be proximate to the build plane whereby resin is replenished between the lower face and the transparent sheet, executing the pump cycle includes vertical motion equal to D, D is at least four times d;
(f) concurrent with the pump cycle, monitoring a signal from a sensor that is indicative of a transient displacement of the transparent sheet; and
(g) updating a motion parameter based at least upon an analysis of the signal from the sensor, the motion parameter defines motion during one or both of steps (a) and (d).

18. The three dimensional (3D) printer of claim 17 updating the motion parameter includes real time updating of motion during one or both of steps (a) and (d).

19. The three dimensional (3D) printer of claim 17 wherein updating the pump cycle includes optimizing a correlation between pump cycle parameters and a geometry of the 3D article.
